(19) United States
(12) Patent Application Publication
(10) Pub. No.: US 2008/0299526 A1
(43) Pub. Date: Dec. 4, 2008

(54) METHOD FOR TEACHING PARENTING TOOLS USING SUPPORTING SOFTWARE

(76) Inventor: Ofer Grosbard, Haifa (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/755,847

(22) Filed: May 31, 2007

(51) Int. Cl. G09B 19/00

(52) U.S. Cl. 434/236

(57) ABSTRACT

A method to support a user in acquiring parenting skills and knowledge according to the parent's chosen parenting-type, using an interactive software application (ISA). The ISA may comprise at least one database, a graphical user interface (GUI) and a business logic. According to embodiments of the present invention the ISA may allow a user to input a target parenting-type, fill a behavioral questionnaire, process the responses filled in the questionnaire, and display the target-rating, where the target-rating representation relates to the parent's selection of the target parenting-type, according to his/her beliefs, cultural background, personal preferences and the like. The responses given in the questionnaire may be associated with tools that are predefined in the ISA, where those tools may help the user in acquiring knowledge regarding the effect of the parent's responses to scenarios and situations upon the parenting-type and eventually upon the child's behavior and attitudes.

### FIELD OF THE INVENTION

The present invention generally relates to the field of parenting methods. More particularly, the present invention relates to the field of parenting diagnosis and training using computerized systems.

### BACKGROUND OF THE INVENTION

Today, there is a growing awareness of parents and educators regarding the relation between parents' responses to their children's behavior or regarding the way in which parents address their children in various scenarios and situations—and the children's development such as their behavior-learning, and developing of perceptions regarding the meaning of success, independent thinking, integrating in the society and the like.

Different parents have different perspectives regarding “a desired development and behavior” of a child or an adolescence—depending on the parents' cultural background, personal perspectives, the norms of the society they live in etc.

In modern society, psychological assessments of a child's development and behavior or a parent's behavior and especially the definition of a problematic behavior and the treatment solutions offered to the parents—do not necessarily take in account the parent's Cultural background and the society the parents live in. For example, where in some societies being a person with an independent thinking or a person who speaks out his mind—is considered a virtue, in other environments and cultures it may be considered vulgar and rude. Therefore educating your child, for example, to speak out his mind may be considered in some environments to be depriving your child of chances to be considered well educated, polite and the like.

A patent application number WO 2006078712 by Robert Field discloses an internet based system for modifying a child's behavior, using a computerized interview process for parenting style diagnosis that generates an electronic behavior rating report. Field's system present parents with issues that may influence their parenting skills, using a parenting style interview. The system produces a parenting plan to minimize the child's problem behavior by changing the parents responses to the child's behaviors. Field's system the rating report indicates the parent's behavior patterns that the parents should address and problematic behaviors associated with those patterns.

Although Field's system and method allow diagnosing the parenting style of the parents—the detection and definitions of “problematic behaviors” is preset in the system and defines the parents responses that produce these behaviors as negative responses. Therefore, Field's does not disclose a system and a method that allow the parents to decide upon “good parenting” and “desirable child's behaviors” according to their background and beliefs. The system may diagnose the parenting style but rate the parent's responses according to a single psychological or behavioral perspective.

### SUMMARY OF THE INVENTION

The present invention is a novel method that allows a user to acquire parenting skills and knowledge, using an interactive software application (ISA), according to the parent's personal preferences regarding the type of parenting he/she wishes to follow.

A user may be any person that uses the ISA, particularly educating persons such as parents, other relatives of a child, a teacher and the like. A child is a generalization of various age groups such as, for example, babies, children and adolescents.

The ISA may allow the user to practice his responses and learn about his/her own behavior and the effects upon the child's behavior and attitude, while considering the differences parents have when regarding the resulting behavior and educational values they hope to pass on to their children. For example, one parent may wish to educate his/her child according to a more traditional set of values, priorities and beliefs, where the sense of belonging to the family and being a part of a group is far more crucial and important than independent thinking and individuality, while for other parents the purposes and targets may follow the exact opposite point of view.

According to some embodiments of the present invention, the ISA enables the user to improve his parenting skills and knowledge according to a “parenting-type” that is inputted or selected out of several (at least two) parenting-types that are defined and distinguished in the ISA system.

According to some embodiments of the present invention, the ISA may allow the user to fill a behavioral questionnaire. The questionnaire may include a set of questions and a set of optional responses regarding the user's optional responses to scenarios and situations described in the questionnaire, each response may represent at least one toot out of a set of predetermined parenting tools defined by the system. A weight-value may be assigned to each response where the weight values may be related to “parenting-types” to allow a rating methodology to establish the degree of the parent's tendency towards at least one of a list of parenting-types, when using the tool and the response described. For example, the parenting-types recognized by the system may be a conservative and a liberal type; and the tools may be, for example, empathy, integration (encouraging of the child's sense of belonging), aggression, rejection, identification, assertiveness and the like. In this case, for example, the weight values related to the parenting-type of liberal and conservative, may be either one or zero for each optional response, where responses that fit a liberal perspective and enhance a liberal education may receive the weight-value of one—while the same response may receive the weight value of zero when weighting this response in a conservative parenting-type, according to this example.

According to embodiments of the present invention, upon filling of at least part of the questionnaire, the ISA may output an indication for the user's parenting skills. This indication may be calculated according to the responses' selections of the user and according to the target parenting-type inputted by the user.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of an interactive software application (ISA) for parenting analysis and behavior, according to some embodiments of the present invention.

FIG. 2 is a schematic illustration of a behavior chart, according to some embodiments of the present invention.

FIG. 3 is a schematic illustration of a part of a behavior questionnaire, according to some embodiments of the present invention.

FIG. 4 is a schematic illustration of a method for teaching parenting skills and knowledge, according to some embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

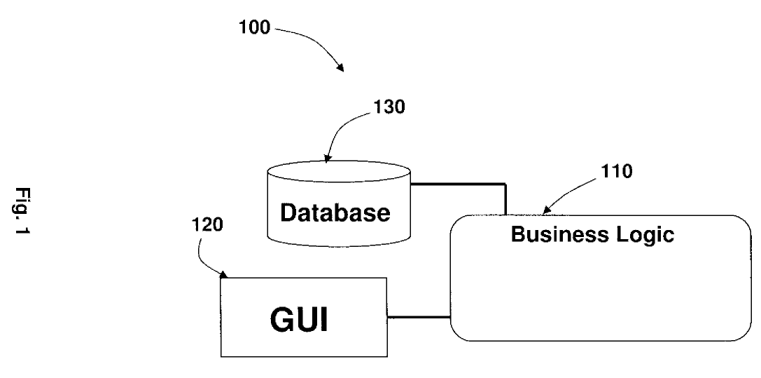

The present invention is a method for teaching parenting related skills and knowledge, using an interactive software application (ISA) 100 that may comprise at least one database 130, a graphical user interface (GUI) 120 and a business logic 110, as illustrated in FIG. 1, according to some embodiments of the present invention.

The ISA 100 may allow a user to input a target parenting-type, according to the parent's desired views of parenting and according to the system's definitions; present at least one scenario and at least two optional responses, where the user may be allowed to select at least one response out of the optional responses; output an indication for the user's parenting. The indication may be calculated according to the responses' selections of the user and the output indication may be presented and calculated by the ISA 100 in relation to the input target parenting-type.

A user may be any person that uses the ISA, particularly educating persons such as parents, other relatives of a child, a teacher and the like. A child is a generalization of various age groups such as, for example, babies, children and adolescents.

According to some embodiments of the present invention, the ISA 100 may allow the user to fill a behavioral questionnaire 10. The questionnaire may include a set of scenarios and a set of optional choices regarding the parent's optional responses to each scenario and situation described in the questionnaire, each response may be associated with at least one tool out of a set of predetermined parenting tools defined by the system. A weight-value may be assigned to each response where the weight values may be related to “parenting-types” to allow a rating methodology to establish the degree of the parent's tendency towards at least one of a list of parenting-types.

For example, the parenting-types recognized by the system may be a modern type and a traditional type; and the tools may represent the responses that encourage an education in the style or direction of the parenting-type. For example, the tools may be: empathy, aggression, rejection, identification, commandment, admiration, politeness, submission, relative title, given name, integration and assertiveness. In this case, for example, the weight values related to the parenting-type of modern and traditional, respectively, may be either one or zero for each optional response.

The tools may be differentiated according to their contribution to one type or another, to some of the types or according to their lack of contribution. For example, the tools of relative title may be opposite to given name—where relative title is when a parent refers to his/her child according to the child's relation to the family/parent, as might be the case in traditional society. For example, calling a daughter—“My daughter”—versus a given name where the parent refers to the child using his/her first name, as is usually the case in modern society. Relative title may encourage the child's sense of belonging to the family and may prevent the child from developing a sense of individuality—where given name may develop a sense of individuality—separated from the family.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not he construed as an admission that such reference is available as prior art to the present invention.

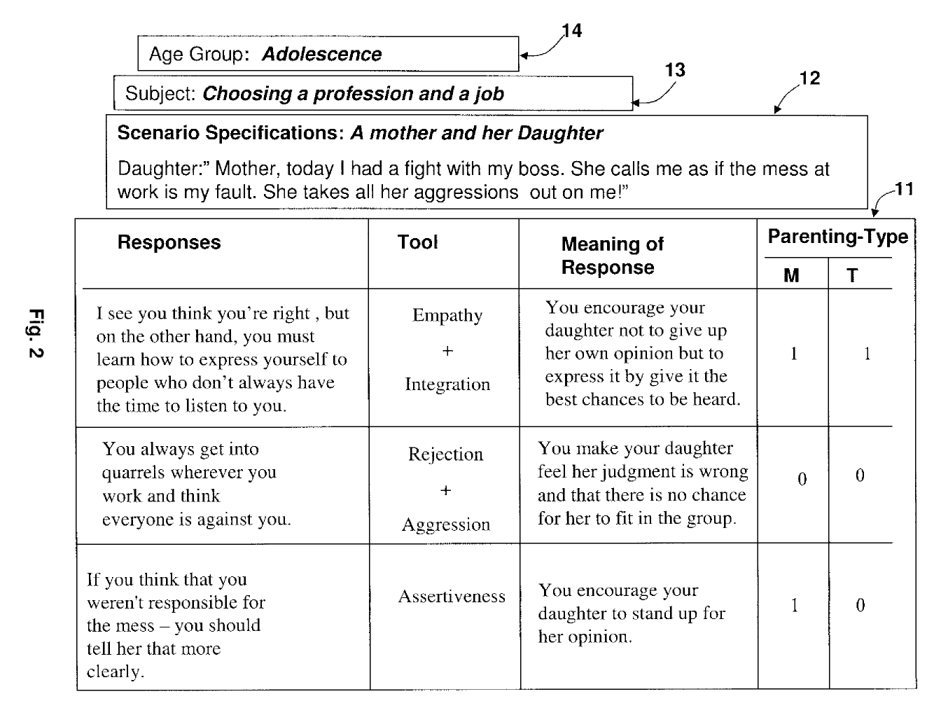

According to some embodiments of the present invention, the business logic 110 may process a behavior questionnaire 10 filled by the user and calculate the “parenting type indication” of the user according to the responses the user has filled in the questionnaire. The questionnaire 10 may comprise possible parent-child situations and scenarios; each scenario may be accompanied with several optional responses; each response may be indicated by an associated tool or tools and by associated weight-values for each parenting-type, as illustrated in the table in FIG. 2.

The system may be designed to guide the users to use the tools that are predefined in the system and practice answering the questionnaire 10 according to a parenting-type chosen by the users. For that matter the ISA 100 may allow the user (through the GUI 120) to select a preferable or a desired “parenting-type target”, where that target may be, for example, (1) one preferred parenting-type according to the parent's beliefs, cultural and religious background etc.; (2) the desired percentages of each parenting-type; (3) the choice of preferred tools.

FIG. 2 schematically illustrates a behavior-chart 11 representing an example of the way the scenarios and their associated information may be stored in the database 130 and/or displayed in an archive option in the GUI 120. The information may be divided into several categories, by which at least some of the search options in the GUI 120 may be carried out. For example: (1) the age group 14 of the child that can be specified by, for example, three age-ranges: infancy (0-6 years), latency (7-12 years) and Adolescent (13-18 years). (2) The subject 13 such as, for example, “learning how to accept authority”, “choosing a profession”, “going to school” etc. (3) Scenario Specifications 12 specifying the situation to which the user must select a response for. The subject category 13, the age group category 14 and the scenario category 12 may be related to one another. For example, the scenarios may be related to the age group, where the parents of a child in a certain age group is more likely to experience certain situations in a higher probability than other (e.g. a scenario such as—getting rid of dippers—may suit the baby age-group much more than the adolescent-age group).

According to some embodiments of the present invention, each scenario may be attached or associated with a behavior chart 11. The behavior-chart 11 may be a list of possible parental responses to the scenaio, the responses meaning or analysis, the tools used in the response and the weight-rate of the parenting-type associated with the response, as illustrated in FIG. 2.

According to embodiments of the present invention, the tools may be prelisted in the ISA 100 and specified according to, for example, at least some of the mental effects of a parent's response upon the child. The set of tools may include, for example, empathy, integrating (encouraging of the child's sense of belonging), aggression, rejection, identification and assertiveness. The list of tools may also comprise combinations of the effects such as, for example, a response that may show the parent's empathy to the child as well as encouraging identification.

According to some embodiments of the present invention, the system may distinguish between two parenting-types: (1) a modern (M) parenting-type that encourages individuality and independent thinking; and (2) a traditional (T) parenting-type that encourages a sense of belonging to a group such as the family or the extended family.

The set of optional responses in the behavior chart 11 may be phrased and set in the system according to the system's definitions of parenting-types.

Additionally, according to some embodiments of the present invention, the ISA 100 may comprise several differentiated groups or lists of parenting-types, where the user may be allowed to choose a parenting-type list out of various distinctions and definitions of the term “parenting-type”. For example, one of the lists may distinguish between the traditional and the modern parenting-types specified above; and a second list may distinguish between a conservative parenting-type and a liberal parenting-type. Each list may be associated with different sets of subjects, scenarios and responses, where at least some of the lists may share some of the scenarios and/or responses.

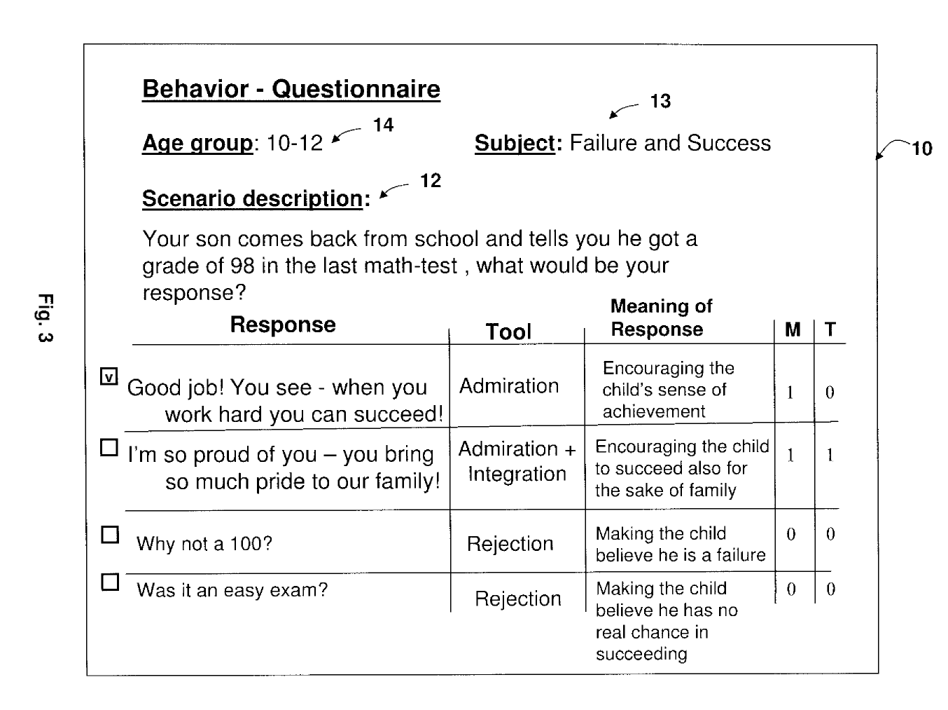

FIG. 3 schematically illustrates a part of a behavior questionnaire 10, according to some embodiments of the present invention. The behavior questionnaire 10 may display the age field query 14 to be filled/selected by the parent; the subject query 13 to be filled/selected by the parent; the scenario description that may automatically appear 12 or selected by the user and the list of optional responses to the specified scenario. The responses' associated tools may be presented accompanying the list of optional responses. The tools may be presented to acknowledge the user regarding the way the response may encourage certain mental reactions and/or effect the child's perceptions and behavior and consequently the parenting-type.

According to embodiments of the present invention, to select a response—the user may be allowed to mark the response of his/her choice, as illustrated in FIG. 3.

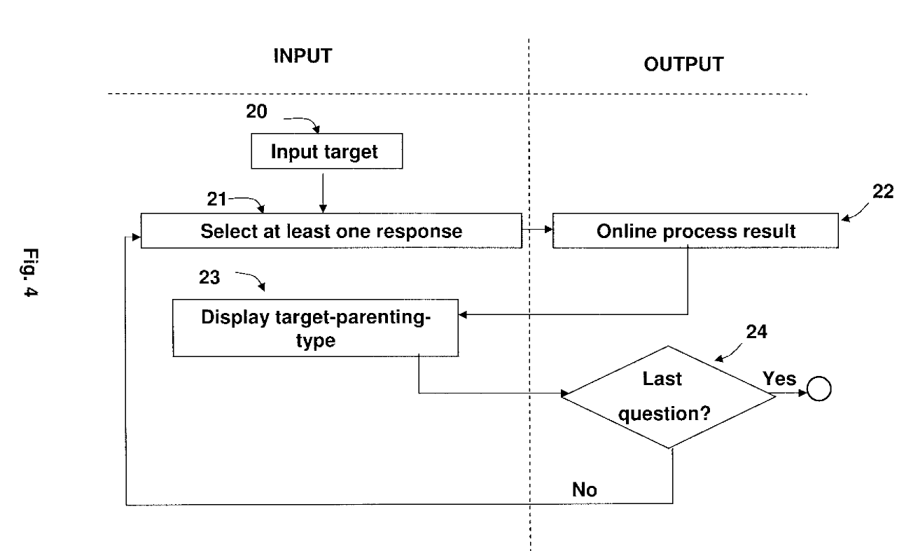

FIG. 4 schematically illustrates a method for teaching parenting skills and knowledge using the ISA 100, according to some embodiments of the present invention. The method may comprise the steps of:
Inputting the target parenting-type 20, wherein the GUI 120 may allow the user to set up the target parenting-type(s) according to the parent's desired targets and according to the system's definitions.
Filling a behavioral questionnaire 21, wherein the GUI 120 may allow the user to respond at least a part of a list of preset questions (scenarios) regarding the parent's responses and the attitude the user exhibits to the child's behavior.
Processing of the responses filled in the questionnaire 22; the analysis of the responses filled by the user may be carried out on or off line depending on the system's predefined options and the parent's choices using the GUI 120.
Displaying the target-rating 23, where GUI 120 may display the parenting-type rating after and/or during the parent's filling of at least some of the scenarios of the questionnaire 10.

According to some embodiments of the present invention, the target-rating may be the percentages of gained points accumulated by using tools (associated with the responses) measuring the acquired parenting-type percentages associated with the responses. For example, tools such as empathy, assertiveness and the combination of both may gain more rating to a modern parenting-type than to a traditional one. Therefore, the more the user fills up responses that relate to these tools the more can the user improve his skills in the modern parenting-type. Practicing to fill up these responses in the questionnaire 10 may help the user to understand the meaning of these tools and how to use these tools in everyday scenarios by being aware to his/her responses and the responses' implications.

According to some embodiments of the present invention, the ISA 100 may calculate and output an evaluation regarding the level of the parenting-types of the parent. For example—the ISA 100 may output the list of parenting-types along with percentages associated with those parenting-types indicating the parent's tendencies to each type. For example, a certain user may fill the questionnaires and receive the results of 25% modern and 75% traditional. This may mean that the user tends to encourage the child's sense of belonging and this may be his parenting-type, but the user also uses some tools that encourage the child to have independent thinking. The ISA 100 may also allow the user to set the target parenting-type in percentages.

According to embodiments of the present invention, to facilitate the user in training and practicing the responses to achieve a target parenting-type—the ISA 110 may allow the user to refill the behavior questionnaire 10 and practice the responses or similar responses to similar scenarios in real-life situations. The ISA 100 may allow the user to set the desired percentages targeted for each parenting-type and allow the user to refill the behavior questionnaire 10 and practice to approach the targeted percentages.

According to some embodiments of the present invention, the lists of parenting-types, the age groups 14, the subjects 13, the scenarios 12, the behavior charts 11 and other related data may be stored in the database 130, along with indication means—indicating the associations between each member (e.g. the subject 13, the age group 14 etc.) and at least some other members in the stored data.

Additionally, the ISA 100 may allow the user to get general knowledge regarding the system, the tools and responses and the like. For that purpose, the ISA 100 may allow the user to search for information using predefined searching-tools in the GUI 120. For example, the user may search by tools and/or search by responses. The search by responses may help the user to check the effects of a response (that may have occurred in a real situation) on the child.

According to embodiments of the present invention, the questionnaire 10 results may be displayed online by the system using graphical representation of the results. For example, the parenting-type results may be set to indicate the percentages calculated and given to each parenting-type, according to the responses filled by the parents and according to the weight-rating methodology. The results may be displayed online in a histogram indicating the percentages level of each type according to the responses filled or selected by the user so far.

According to embodiments of the present invention, the user may fill the questionnaire, using GUI 120 options, before selecting a parenting-type to establish the user's current parenting-type. The ISA 100 may present a set of scenarios and request the user to select responses that he/she believe would be his/her responses in a real-life situation.

According to some embodiments of the present invention, the ISA 100 may be a web application enabling storing of questionnaires-data and statistically accumulating the responses to scenarios selected by users and analyze these responses in relation to the selected parenting-types associated with the responses—to allow statistically changing of the weight-values of responses according to the users' statistical responses and chosen parenting-types. This may allow measuring the relation between the response and the tools. For example, if more users that have targeted towards a traditional parenting-type have selected a specific response to a specific scenario that is associated with the tool of empathy—a tool related (by the system) to a modern parenting-type—than, for instance the ISA 100 may reconsider the relation between this tool and the phrasing of the response or the weight-value of this response associated with a traditional parenting-type.

Additionally, the ISA 100 as a web application may enables viewing other users' selections and resulting indications.

According to embodiments of the present invention, the ISA 100 as a web application may allow the user to input his/her own scenarios and optional responses—inserting the users' suggestions into the statistics of scenarios and responses. For this matter the ISA 100 may comprise an algorithm to allow processing the input scenarios and responses practiced and offered by the users.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A method for teaching parenting related skills and knowledge, using an interactive software application (ISA) that comprises at least one database, a graphical user interface (GUI) and a business logic, said method comprising the steps of:
inputting the target parenting-type, wherein the GUI allows the user to set up the target parenting-type according to the parent's desired targets and according to the system's definitions;
presenting at least one scenario and at least two optional responses, wherein the user is allowed to select at least one response out of the optional responses;
outputting an indication for the user's parenting, wherein said indication is calculated according to the response's selections of the user;
wherein the output indication is presented and calculated in relation to the input target parenting-type.

2. The method of claim 1 wherein inputting the target parenting-type includes inserting the percentages of each parenting-type that the user selects, using the GUI.

3. The method of claim 2 wherein the output indication is graphically represented along with a graphical representation of the target parenting-types percentages.

4. The method of claim 3 wherein the outputting of the indication for the user's parenting is carried out online.

5. The method of claim 3 wherein the outputting of the indication for the user's parenting is carried out offline.

6. The method of claim 1 wherein calculating the resulting indication is carried out according to weight-values associated with each response and each parenting-type.

7. The method of claim 1 wherein the presentation of the scenarios and responses is carried out in a format of a questionnaire.

8. The method of claim 7 wherein the user is enabled to fill the questionnaire, using GUI options, before selecting a parenting-type—to establish the user's current parenting-type.

9. The method of claim 1 where each response is associated with a parenting tool and with a weight-value for each the parenting-type, wherein the parenting types predefined by the system are: modern parenting-type and traditional parenting type.

10. The method of claim 9 wherein the tools that are predefined by the system as encouraging a traditional parenting type are: identification, relative title, commandment and submission;
wherein the weight value of said tools is zero for a modern parenting-type.

11. The method of claim 9 wherein the tools that are predefined by the system as encouraging a modern parenting type are: empathy, empathy, given name, politeness, assertiveness and admiration;
wherein the weight value of said tools is zero for a traditional parenting-type.

12. The method of claim 9 wherein the tools of aggression and rejection have the weight-value of zero for a traditional and for a modern parenting-type.

13. The method of claim 1 wherein the parenting-types are defined by the ISA according to the relevant age group.

14. The method of claim 13 wherein each age group is associated with a predefined list of parenting-types and a predefined list of scenarios, wherein each scenario is associated with at least two optional responses and their associated tools.

15. The method of claim 1 wherein the parenting types defined by the system are:
a traditional parenting-type that encourages a sense of belonging to a group; and
a modern parenting-type that encourages individuality and independent thinking.

16. The method of claim 6 further comprising the steps of:
storing of users' questionnaires-data;
statistically accumulating the responses to scenarios selected by users; and
analyzing these responses in relation to the selected parenting-types associated with the responses.

17. The method of claim 16 further comprises the step of presenting other users' selections and resulting indications.

18. The method of claim 16 further comprises the step of inputting scenarios and responses, wherein the users use the ISA GUI to input their own scenarios and the scenarios' associated responses.
